(19) United States
(12) Patent Application Publication
(10) Pub. No.: US 2003/0196698 A1
(43) Pub. Date: Oct. 23, 2003

(54) Axial flow control valve

(75) Inventors: Chin-Shun Lin, Ying-Ke Town (TW); Kuo-Hung Lin, Taipei (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Metal Industries Research & Development Centre

(21) Appl. No.: 10/125,122

(22) Filed: Apr. 17, 2002

(51) Int. Cl. F16K 1/00

(52) U.S. Cl. 137/219

(57) ABSTRACT

An axial flow control valve comprises a valve body having a flow passage containing therein a cylinder and an annular sleeve both are held in position by a positioning sleeve. The annular sleeve has a wall member formed with a multi-pores means for providing a number of V-shaped or elongate ports for reducing noise and vibration of fluid flow. A push rod is axially movably disposed within the cylinder, having one end attached with a resiliently biasing means for resiliently engaging a valve piston axially displaceable within the cylinder and the annular sleeve for controlling fluid flow. The positioning sleeve is formed with a truncated conical valve seat to associate with the valve piston for sealingly occluding fluid flow. O-rings made of resiliently metallic or ceramic material are disposed on the valve piston and/or the push rod for sealing the axially movable elements, so that the valve can be used in a high-temperature environment. The present invention provides an axial flow control valve having characteristics low pressure drop, high fluid flow, reduced noise and vibration, suitable for use in high-temperature environment, less frictional resistance between the valve piston and valve seat, minimized operational torque, simplified construction and ease of manufacturing.

### BACKGROUND OF THE INVENTION

1. Field of the Invention

The present invention relates to an axial flow control valve, and particularly to an axial flow control valve having beneficial characteristics—low pressure drop, high fluid flow, reduced noise and vibration, suitable for use in a high-temperature environment, less frictional consumption between the valve piston and valve seat, reduced operational torque, simplified construction and ease of manufacturing.

2. Description of Related Art

Conventionally, globe valves, e.g. U.S. Pat. No. 4,397,331, are applied for controlling fluid flow. As known, such type of valve is used to apply in linear or proportional control of fluid flow, bearing advantageous features of having steady fluid flow, and also bearing the drawbacks of large pressure drop and small fluid flow across the valve.

As also known, a ball valve has beneficial features of low pressure drop and high fluid flow, but conventionally can only apply in a full-open/full-close condition. Therefore, in an arrangement of fluid transportation pipelines, convergent ball valves are usually applied in association with globe valves to control fluid flow. Recently, improved flow control ball valves, such as the one disclosed in U.S. Pat. Nos. 5,074,522 or 5,551,467, are provided to replace conventional globe valves for controlling fluid flow, and then have characteristic of relatively large fluid flow transportation. It, however, is poor in control stability and in fluid flow stability, and thus is unsuitable for use in a processing pipeline. Besides, such type of valve tends to create noise, flow turbulence and pitting.

As illustrated in FIG. 1, the axial flow control valve suggested in U.S. Pat. No. 4,327,757 is an improved fluid flow control valve having beneficial characteristics—reduced pressure drop, increased fluid flow, stable fluid flow, and reduced operation torque. It, however, is complicated in construction and cannot be manufactured easily. Especially, since the axial flow control valve occludes the fluid flow passage totally by the valve piston slidably to move along the cage sleeve, and a sufficient clearance shall be maintained between the piston and the cage sleeve to allow the piston slidably moving along the cage sleeve, the piston slidably moving along the cage sleeve cannot create a good occluding and sealing effect to fluid flow. Though U.S. Pat. No. 4,892,287 discloses a sealing construction of a valve piston (see FIGS. 2A and 2B) that can be applied to the axial flow control valve as disclosed in U.S. Pat. No. 4,327,757 to create a “pressured self-lock” effect and maintaining the sealing effect between the piston and cage sleeve, the sealing material applied therein is soft material, e.g. rubber, and unsuitable for use in a high temperature environment of above 250° C., and hence cannot pass AP1607 fire test, Besides, the pressured self-lock function as suggested in U.S. Pat. No. 4,892,287 is also unsuitable for use in a low-pressure environment. Particularly, with reference to FIGS. 2A and 2B, the sealing ring made of soft material is resiliently deformed by a fluid pressure applied on an upstream side thereof, so that the sealing ring projects radially and outwardly to compress against the inner surface of a cylindrical valve housing. Therefore, if the pressure applied to the upstream side of the sealing ring is too small to resiliently deform the sealing ring, the sealing ring shall be unable to deform to tightly compress against the inner surface of the cylindrical valve housing to create a good sealing effect. The sealing ring, under a low-pressure operating condition, cannot create good sealing function and will cause fluid leakage.

### SUMMARY OF THE INVENTION

Accordingly, an object of the present invention is to provide an axial flow control valve that is suitable for use in a high-temperature operating environment and having beneficial characteristics of low pressure drop and high fluid flow, so that when scheming and planning an industrial process, the maximal fluid flow of a pipeline can be applied without the adverse considerations and limitations caused by the arrangement of valves, and hence the cost of equipment is reduced. In already installed process equipment, if the valves suggested in the subject invention are applied to replace the conventional control valves, the productivity and efficiency can also be significantly increased and improved.

A further object of the present invention is to provide an O-ring made of resiliently metallic or ceramic material for sealing a valve piston or a push rod, and the valve piston and the valve seat are engaged each other in a metal-to-metal manner, so that the axial flow control valve is suitable for use in a high-temperature operating environment and can pass AP1607 fire test.

A still further object of the present invention is to provide an annular sleeve having a wall member formed with a variety of slots, such as elongate slots, V-shaped ports and etc., so as to provide various operational flow characteristics, such as linear control or proportional control.

A still further object of the present invention is to provide a multi-pores device to replace the slots, and to resiliently bias the valve piston against the push rod by a resiliently biasing means, so as to reduce the vibration and noise during operation.

A still further object of the present invention is to provide an axial flow control valve having characteristics of simplified construction and ease of manufacturing.

To accomplish the above objects, the present invention provides an axial flow control valve comprising:

a valve body having a longitudinal axis and formed along the fluid flowing direction with an inlet flow passage, a valve chamber and an outlet flow passage, in which the valve body is formed with a through hole perpendicular to the longitudinal axis and corresponding to the valve chamber of the valve body;

a cylinder detachably disposed within the valve chamber having a first end and a second end, in which the first end faces to the inlet flow passage and formed as a conical diverter, and the second end formed with a central push rod hole and a cylindrical flange, a valve stem inserting hole formed on a lateral wall of the cylinder at a place corresponding to the through hole of the valve body;

a push rod having a first end and a second end, in which the first end is formed with a rack and slidably displaceable within the push rod hole of the cylinder, and the second end projecting out of the push rod hole;

a valve piston substantially in a cylindrical configuration including a conical head portion and a cylindrical skirt portion, in which the head portion is formed with a central shaft hole to engage the second end of the push rod, so that the skirt portion of the valve piston is axially displaceable within the cylindrical flange of the cylinder, and an annular sealing edge formed at the intersection of the cylindrical head portion and the cylindrical skirt portion;

an annular sleeve substantially in a cylindrical configuration interposed between the valve chamber and the outlet flow passage and formed with a first end and a second end, and a cylindrical wall member formed between the first end and the second end, the wall member formed with a plurality of through bores, the first end used to engage the cylindrical flange of the second end of the cylinder, to allow the valve piston to slidably move between the first and the second ends of the annular sleeve;

a positioning sleeve substantially in a cylindrical configuration having a first end and a second end, in which the first end compressively engages the second end of the annular sleeve and is formed with a conical valve seat at the inner circumferential edge to sealingly engage the annular sealing edge of the valve piston;

a valve bonnet comprising a central valve stem tube formed therein with a central valve stem hole, the valve stem tube passing through the through hole of the valve body and extending to the valve chamber to engage the valve stem inserting hole of the cylinder; and

a valve stem having a first end and a second end, in which the first end is formed with a gear and pivotally passing through the central valve stem hole of the valve bonnet and extending into the cylinder to drivingly engage the rack of the push rod;

wherein the valve piston and the cylinder, and the push rod and the cylinder, are provided therebetween an O-ring made of resiliently metallic or ceramic material to serve as sealing material;

wherein the valve body and the valve bonnet, the valve bonnet and the cylinder, and the cylinder and the valve body, are provided therebetween with graphitic material for creating sealing effect;

wherein the valve piston is resiliently disposed on the push rod by resiliently biasing means.

Additional objects, advantages, construction, and features of the present invention will become apparent through the following description and the appended claims, in conjunction with the accompanying drawings.

### BRIEF DESCRIPTION OF THE DRAWINGS

FIG. 1 is an schematically cross-sectional view showing the construction of a conventional axial flow control valve;

FIGS. 2A & 2B are schematic views showing the construction and operation of a conventional valve having pressured self-lock valve seat construction;

FIG. 3 is a perspective view of a preferable embodiment of the axial flow control valve in accordance with the present invention;

FIG. 4 is a fragmentally cross-sectional view illustrating the construction of the axial flow control valve of the present invention;

FIG. 5 is an exploded perspective view showing the construction of the axial flow control valve of the present invention;

FIG. 6 is a schematically longitudinally and vertically cross-sectional view of the preferable embodiment of the axial flow control valve of the present invention, illustrating the internal construction of the axial flow control valve and the operation thereof in association with a servo-actuator;

FIG. 7 is a schematically, longitudinally, and horizontally cross-sectional view of the preferable embodiment of the axial flow control valve of the present invention, illustrating that the valve is in a fully-open state where the valve piston does not contact the annular sleeve to occlude the is fluid flow passage;

FIG. 8 is another schematically, longitudinally, and horizontally cross-sectional view of the preferable embodiment of the axial flow control valve of the present invention, illustrating that the valve piston is driven by the push rod and biased by the disk springs to directly, resiliently and sealingly compress against the valve seat, so as to maintain the valve in a fully-close state;

FIG. 9A is a perspective view of the preferable embodiment of the resiliently metallic O-ring in accordance with the present invention, in which the O-ring is partially cut off to facilitate the viewing of the construction thereof;

FIG. 9B is a transverse cross-sectional view of the resiliently metallic O-ring illustrated in FIG. 9A; and

FIG. 10 is a fragmentally cut-off perspective view showing the state that the resiliently metallic O-ring illustrated in FIG. 9 is disposed between the valve piston and the cylinder to allow the valve piston to axially move relatively to the cylinder, and illustrating that the outer circumferential surface of the O-ring together with graphitic material attached thereon is sealingly received within the annular sealing groove, and the inner circumferential surface of the O-ring providing a smooth sliding face to sealingly engage the cylindrical skirt portion of the valve piston.

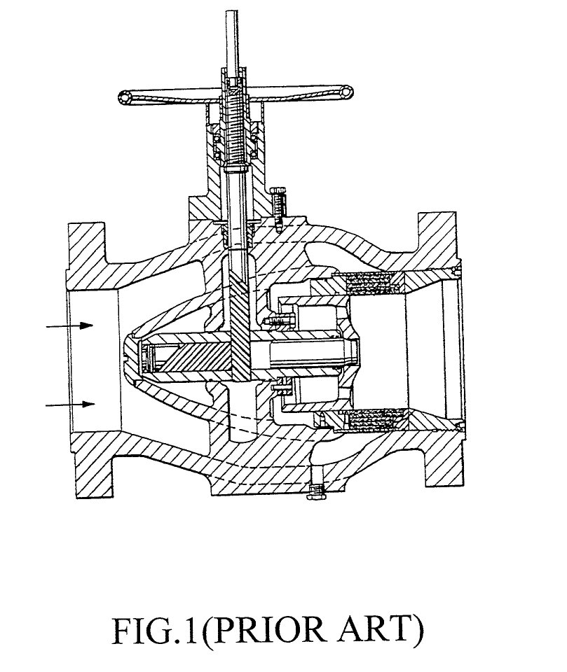

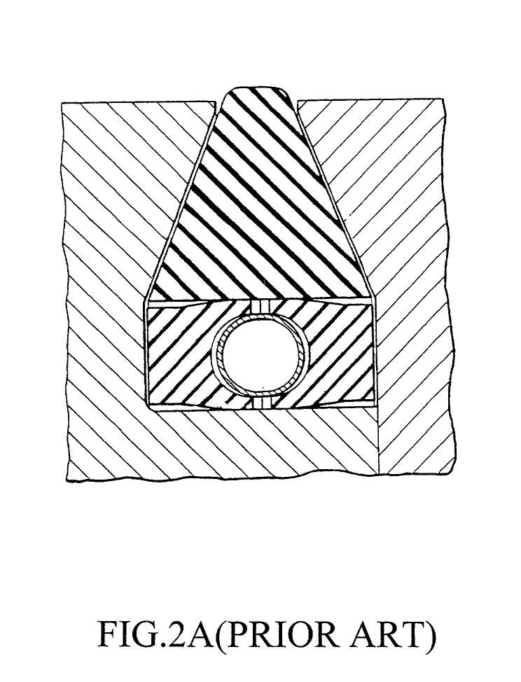

### PREFERRED EMBODIMENT OF THE PRESENT INVENTION

Certain terminology may be employed in the following description for convenience rather than for any limiting purpose. For example, the terms “forward,” “rearward,” “right,” “left,” “upper,” and “lower” designate directions in the drawings to which reference is made, with the terms “inward,” “inner,” or “inboard” and “outward,” “outer,” or “outboard” referring, respectively, to directions toward and away from the center for the referenced element, the terms “radial” and “axial” referring, respectively, to directions or planes perpendicular and parallel to the longitudinal central axis of the referenced element, and the terms “downstream” and “upstream” referring, respectively, to directions in and opposite that of fluid flow. Terminology of similar import other than the words specifically mentioned above likewise is to be considered being used for purposes of convenience rather than in any limiting sense.

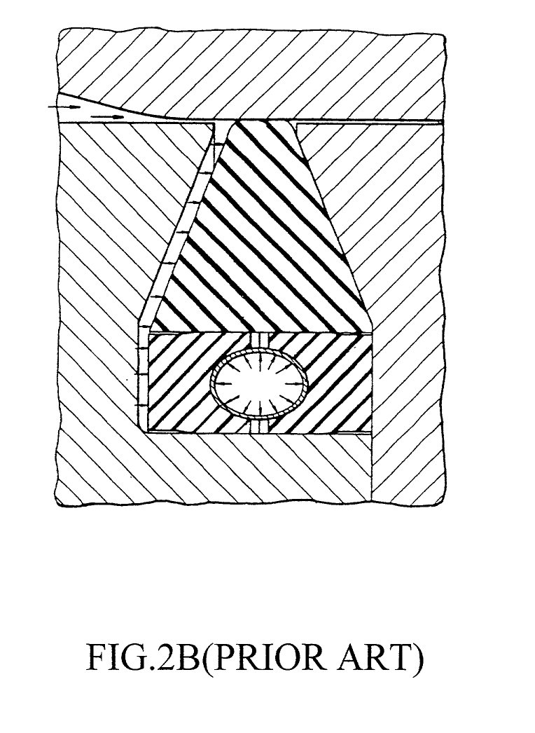

Referring to FIGS. 3, 4 and 5, an axial flow control valve in accordance with a preferable embodiment of the present invention comprises a valve body 1, a cylinder 2, a push rod 3, a valve piston 4, an annular sleeve 5, a positioning sleeve 6, a valve bonnet 7, and a valve stem 8.

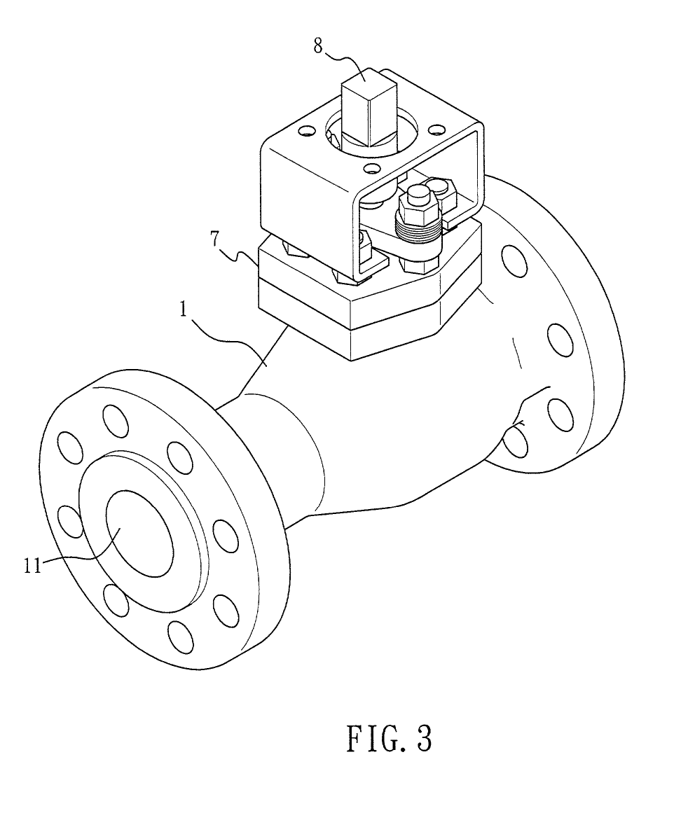

As illustrated in FIGS. 4, 5, 6 and 7, the valve body 1 has a longitudinal axis L and formed therein along the fluid flowing direction an inlet flow passage 11, a valve chamber 12 and an outlet flow passage 13. A through hole 14 is vertically formed on valve body 1 and extending substantially perpendicular to the longitudinal axis L into the valve chamber 12.

The cylinder 2 is disposed within the valve chamber 12 and having a first end 21 and a second end 22 opposite to the first end 11, in which the first end 21 faces to the inlet flow passage 11 and formed as a conical diverter 211 for uniformly directing fluid flow from the inlet flow passage 11 into the valve chamber 12. The cylinder 2 has a top formed with a valve stem inserting hole 23 coaxially aligning with the through hole 14 of the valve body I and perpendicular to the longitudinal axis L. The second end 22 is formed with a central push rod hole 24 extending substantially along the longitudinal axis L. The push rod hole 24 has a terminal end outer wall formed with threaded portion (no shown). The second end 22 of the cylinder 2 is also formed with a cylindrical flange 25 extending substantially along the longitudinal axis L.

The push rod 3 is substantially a round rod having a first end 31 and a second end 32 opposite to the first end 31, in which the first end 31 is formed with a rack 33 extending to a mid-section of the push rod 3. The second end 32 of the push rod 3 is formed with a step-like shoulder 321 and a threaded portion 322 formed at the terminal end thereof. The push rod 3 is used to receive within the push rod hole 24 of the cylinder 2. An O-ring 34 surrounds the push rod 3 and is compressed to abut against the push rod 3 by a gland nut 35 threadedly engaging on the terminal end outer wall of the push rod hole 24, so that the push rod 3 can reciprocate along the push rod hole 24. The O-ring 34 can be made of material with high heat resistance and low frictional resistance, such as resiliently metallic material or ceramic material. The shoulder 321 projects out of the gland nut 35 and is coaxially arranged with a number of disc springs 36. The shoulder 321 has a terminal end formed as a threaded portion 322 to associate with a nut 37 for securing.

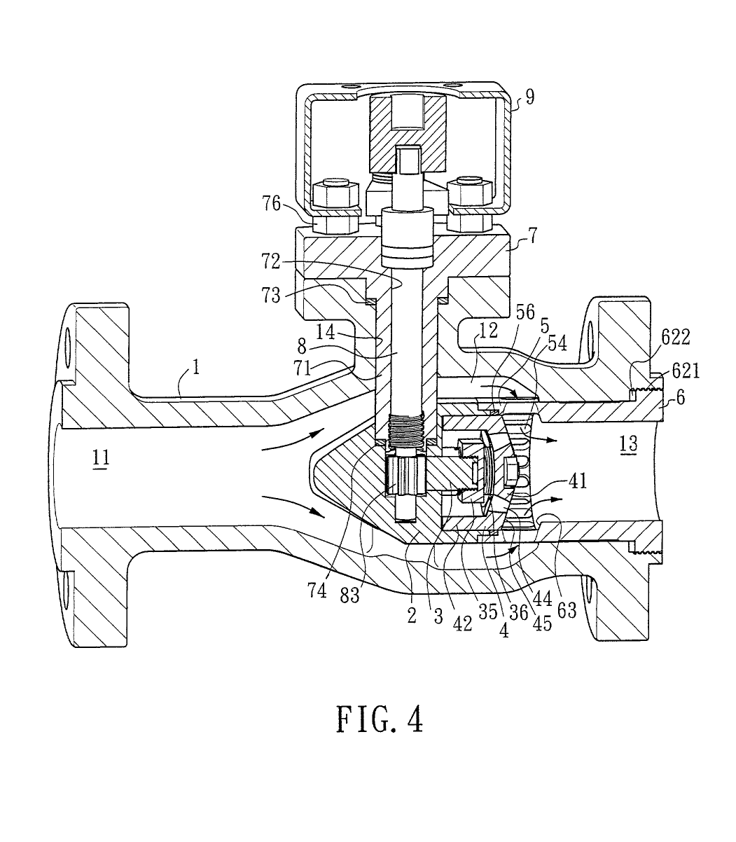

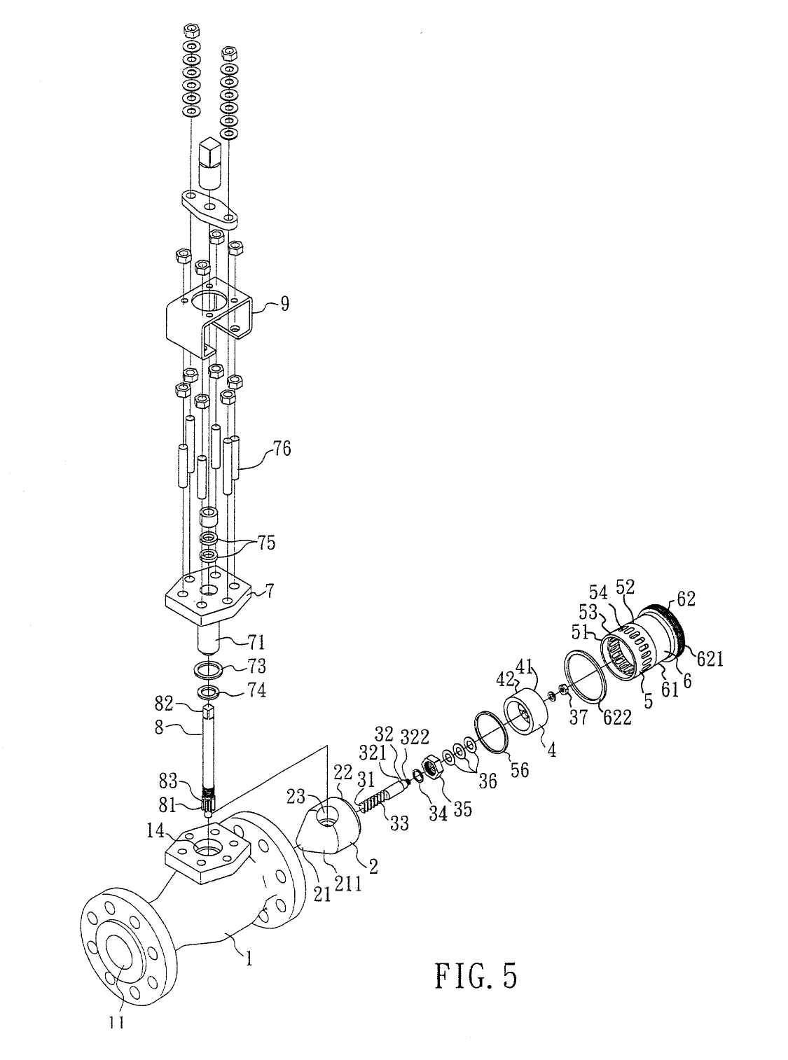

Referring to FIGS. 5 and 6, the valve piston 4 is substantially in a cylindrical configuration having an open end, and comprises a conical head portion 41 and a cylindrical skirt portion 42 extending substantially along the longitudinal axis L. The conical head portion 41 is formed with a central shaft hole 43 to allow the second end 32 of the push rod 3 to pass therethrough. The screw nut 37 is threadedly secured on the threaded portion 322 of the push rod 3, so that the valve piston 4 engages the second end 32 of the push rod 3, and so that the piston 4 is resiliently biased against the push rod 3 by the number of disc springs 36. As best illustrated in FIG. 6, the conical head portion 41 of the valve piston 4 is further formed with a plurality of communicating through holes 44. The cylindrical skirt portion 42 is movably received within the cylindrical flange 25. An annular sealing edge 45 is formed on the conical head portion 41 around the intersection of the conical head portion 41 and the cylindrical skirt portion 42. The valve piston 4 can be made of metallic or ceramic material.

The annular sleeve 5 is substantially in a cylindrical configuration and interposes between the valve chamber 12 and the outlet flow passage 13. The annular sleeve 5 comprises a first end 51 and a second end 52 opposite to the first end 51. A cylindrical wall member 53 is formed between the first end 51 and the second end 52 for movably receiving therein the cylindrical skirt portion 42 of the valve piston 4. The cylindrical wall member 53 is formed with a plurality of through bores 54 uniformly spaced one another, for allowing fluid to flow from valve chamber 12 toward the outlet flow passage 13. The first end 51 of the annular sleeve 5 abuts against the terminal end of the cylindrical flange 25, and formed therebetween an annular sealing groove 55, for receiving therein an O-ring 56 to sealingly engage the cylindrical skirt portion 42 of the valve piston 4. The O-ring 56 can be made of resiliently metallic material or ceramic material with high heat resistance and low fictional resistance.

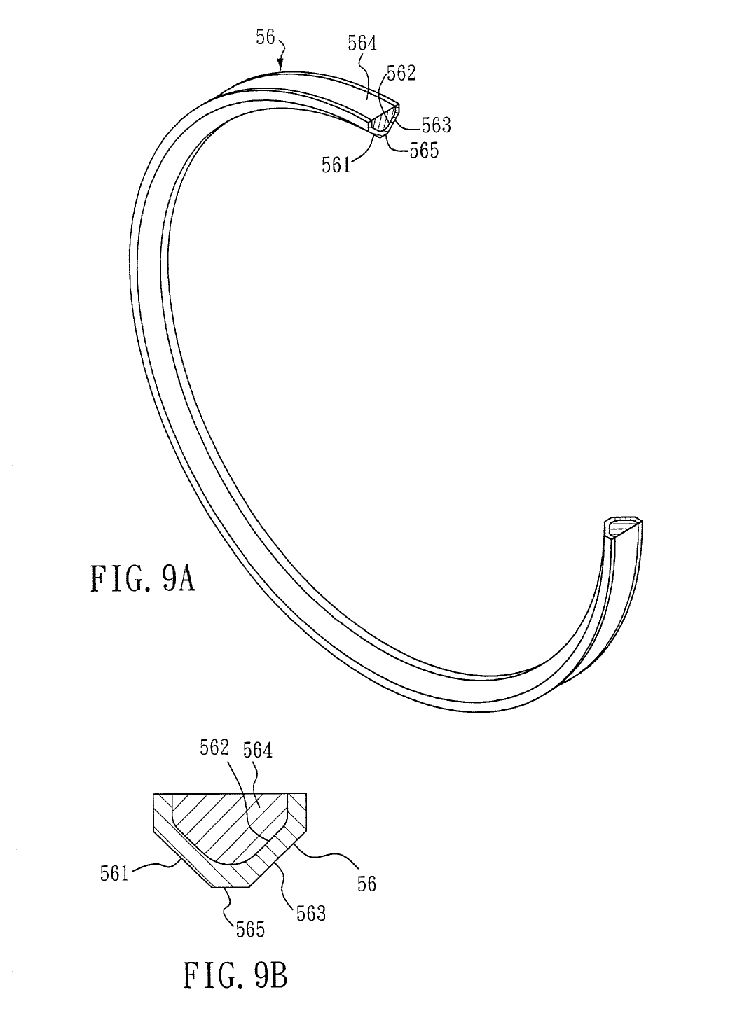

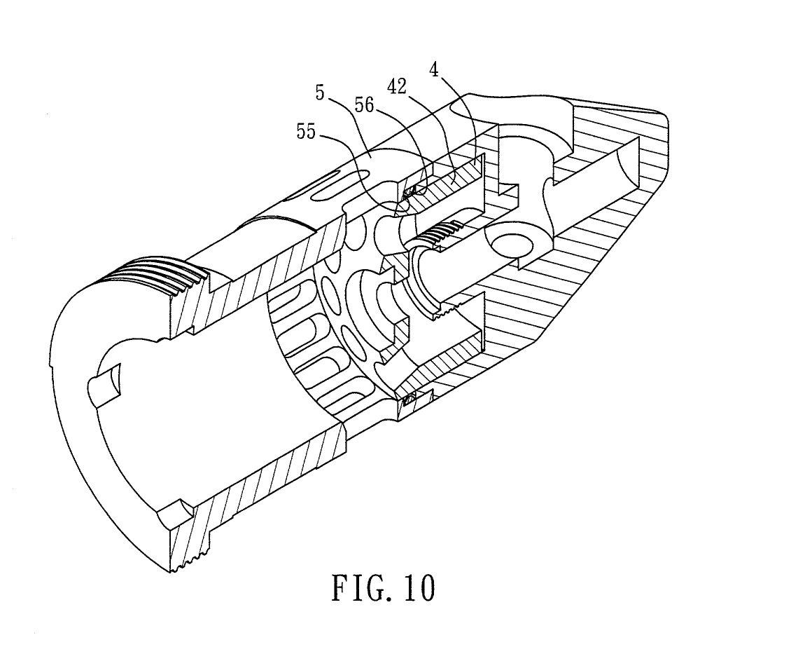

FIGS. 9A and 9B illustrate an embodiment of the O-ring 56 made of resiliently metallic material. The construction of the resiliently metallic O-ring 56 mainly comprises an annular ring 561 made of metallic material having a V-shaped or trapezoid shaped cross-section, e.g. the V-shaped cross-section illustrated in FIGS. 9A and 9B, and comprising an outer circumferential surface 562 and an inner circumferential surface 563. The outer circumferential surface 562 is opened radially and securely attached thereon with graphitic material 564 which is heat resistant and slightly compressible, so that the O-ring 56 can be received and rest within the annular sealing groove 55 (see FIG. 10), maintaining a sealing effect relative to the sealing groove 55. The inner circumferential surface 563 of the resiliently metallic O-ring 56 is closed and formed with a smooth sliding contact surface 565 for resiliently and sealingly abutting against the cylindrical skirt portion 42 of the piston 4 (see FIG. 10), so that the valve piston 4 can sealingly and axially move relatively to the resiliently metallic O-ring 56. Especially, if the valve piston 4 is made of ceramic material, the frictional resistance between the valve piston 4 and the O-ring 56 will be further greatly reduced.

The resiliently metallic O-ring 56 suggested in the present invention can also be applied as a sealing member for any other mechanical components that require relatively axial movement, such as a piston and a cylinder, and a plug and hydraulic cylinder.

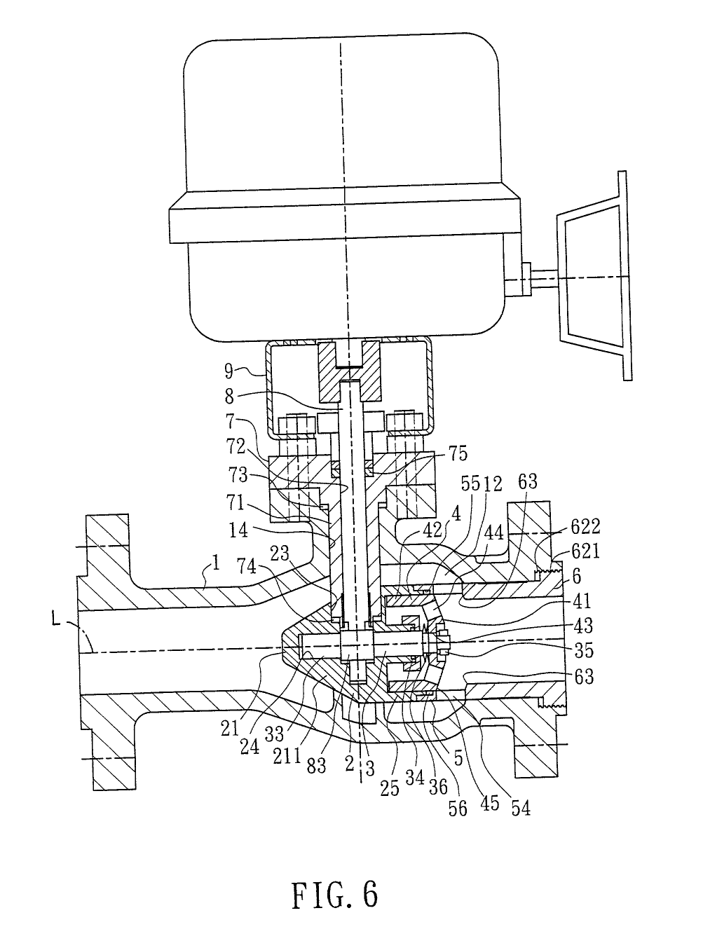

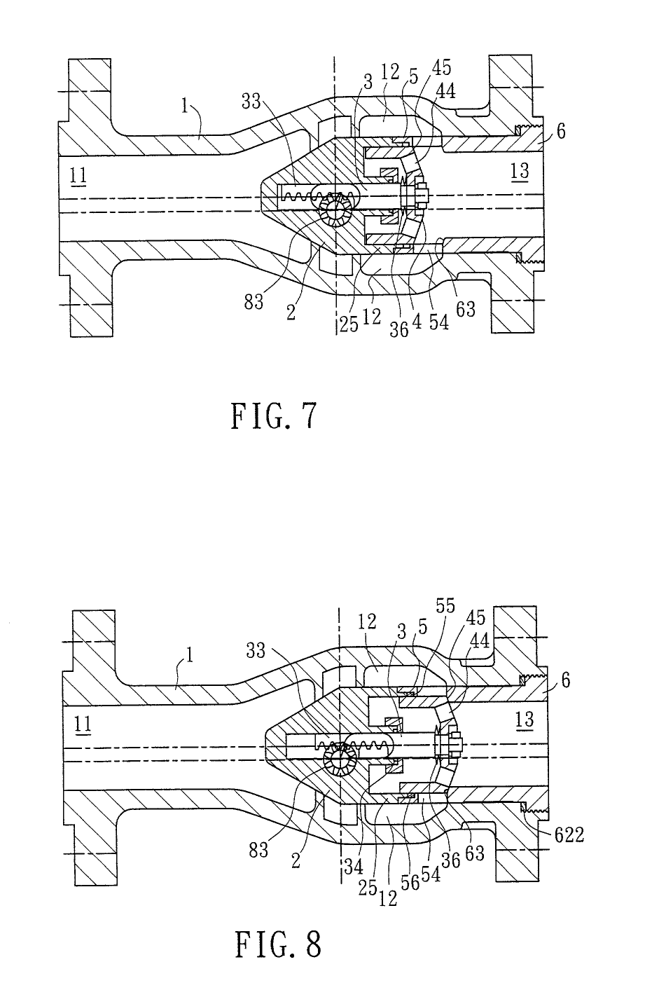

Referring to FIGS. 5 and 8, the positioning sleeve 6 is substantially in a cylindrical configuration, comprising a first end 61 and a second end 62, in which the second end 62 is formed with an external threaded portion 621 for threadedly engaging the internal thread (see FIG. 7; with no reference numeral) of the outlet flow passage 13. A graphitic ring 622 can be additionally disposed between the positioning sleeve 6 and the valve body 1 to achieve a sealing effect. The first end 61 of the positioning sleeve 6 exactly abuts against the second end 52 of the annular sleeve 5 and is formed with a conical valve seat 63 (see FIG. 6) to sealingly engage the annular sealing edge 45 of the conical head portion 41 of the valve piston 4. The valve seat 63 of the positioning sleeve 6 engages the sealing edge 45 of the valve piston 4 in a conical connecting interface as illustrated in FIG. 6, or in a simple annular flat interface.

The valve bonnet 7 includes a central valve stem tube 71. The valve stem tube 71 is centrally formed with a valve stem through hole 72 extending into the valve chamber 12 and allowing the valve stem tube 71 to insert into the valve stem inserting hole 23 of the cylinder 2. Graphitic rings 73 and 74 are disposed at the interconnection of the central valve stem tube 71, the valve body 1 and the cylinder 2. The valve bonnet 7 is secured to the valve body 1 by a plurality of bolts 76.

The valve stem 8 is substantially a round rod having a first end 81 and a second end 82, in which the first end 81 is formed with a construction, such as a rod with a rectangular cross-section, adapted to be rotationally driven. The second end 82 is formed with a gear 83 to cooperate with the rack 33. The valve stem 8 extends through the valve stem tube 71 of the valve bonnet 7 and the valve stem inserting hole 23 of the cylinder 2, so that the gear 83 formed at the second end 82 of the valve stem 8 drivingly engages the rack 33, and so that the first end 81 of the valve stem 8 extends out of the valve bonnet 7. Graphitic rings 75 are disposed between the valve stem 8 and the valve bonnet 7 for obtaining a sealing effect therebetween. The cylinder 2 has an inside bottom formed with circular recess (not shown) for pivoting the valve stem 8.

Referring to FIG. 6, the valve bonnet 7 is additionally provided with a servo-actuator seat 9 for installing a hydraulic actuator or electric servomotor, so as to drive the valve stem 8 by power. The valve stem 8 can also be manually operated by way of a hand wheel, an operating lever or the like.

As illustrated in FIGS. 5, 6, and 7, when the valve stem 8 rotates the gear 83 to associate with the rack 33 to pull back the push rod 3, the valve piston 4 resiliently disposed on the second end 32 of the push rod 3 is pulled back by the push rod 3, so that the cylindrical skirt portion 42 of the valve piston 4 axially slides relatively to the annular sleeve 5, opening the through bores 54 to a desired valve opening to allow fluid to flow from the valve chamber 12 toward the outlet flow passage 13. The more the valve piston 4 gets close to the cylinder 2, the larger the opening of the through bores 54 will be. FIG. 7 illustrates that the axial flow control valve is in a fully-open state.

As illustrated in FIGS. 5, 6 and 8, when the valve stem 8 rotates the gear 83 to associate with the rack 33 to move the push rod 3 axially forward, the valve piston 4 attached on the second end 32 of the push rod 3 is axially moved by the push rod 3, so that the cylindrical skirt portion 42 of the valve piston 4 axially slides relatively to the annular sleeve 5, reducing the opening of the through bores 54, so as to reduce or occlude the fluid flow from the valve chamber 12 to the outlet flow passage 13. The more the valve piston 4 gets farther to the cylinder 2, the smaller the opening of the through bores 54 will be. FIG. 8 illustrates that the axial flow control valve is in a fully-close state.

When the valve is fully opened, the cylindrical skirt portion 42 of the valve piston 4 abuts and occludes all through bores 54 of the annular sleeve 5, and the annular sealing edge 45 of the conical head portion 41 of the piston 4 compressively engages the conical valve seat 63, and thus can strictly prevent from any fluid leak toward the outlet flow passage 13. Since the valve piston 4 compressively and sealingly engages the valve seat 63 in a “metal-to-metal” manner, even if the fluid pressure is very small, no leakage will occur between the valve seat 63 and the annular sealing edge 45, which avoids the drawbacks of the sealing construction for axial flow control valve as suggested in U.S. Pat. No. 4,892,287 in which small leakage would occur if the operational pressure is too small. Besides, since the “metal-to-metal” engagement between the valve seat 63 and the annular sealing edge 45 applies no soft sealing material, the axial flow control valve, even suffering a high temperature of above 250° C., will not lose sealing effect, and thus can pass AP1607 fire test.

Since the disc springs 36 are resiliently interposed between the push rod shoulder 321 and the conical head portion 41 of the valve piston 4, when the push rod 3 moves the valve piston 4 to abut against the valve seat 63, the disc springs 36 apply a resiliently biasing force to compress the annular sealing edge 45 of the valve piston 4 against the valve seat 63, so as to ensure that the annular sealing edge 45 of the valve piston 4 tightly and compressively engages the valve seat 63, and so as to prevent that the push rod 3 overly pushes to valve piston 4 and damages the valve seat 63.

Referring to FIGS. 5, 6 and 7, since the O-ring 56 interposed between the cylindrical skirt portion 42 and the cylindrical flange 25, and the O-ring 34 interposed between the push rod 3 and the cylinder 2 are all the sealing member with high heat resistance and low frictional resistance, the axial flow control valve provided by the present invention can resist high-temperature above 250° C., without losing sealing function. Further, since the O-rings 34 and 56 made of resiliently metallic or ceramic material are of low frictional resistance, the frictional resistance to the valve piston 4 and the push rod 3 is significantly minimized, so that the operational torque required for rotating the valve stem 8 is also significantly minimized.

In addition to the O-rings made of resilient metallic or ceramic material and interposed between relatively movable components such as the push rod and the cylinder, and the valve piston and the cylinder, to serve as sealing members, the present invention applies high heat resistant graphitic rings 73, 74, 75, 76 and 622 to interpose between the valve bonnet and the valve body, the valve stem and the cylinder, the positioning sleeve and the valve body to serve as sealing member, so that the axial flow control valve of the present invention totally meets the requirements for operation under high-temperature condition, and can pass AP1607 fire test.

As illustrated in FIGS. 6, 7 and 8, since the conical head portion 41 of the valve piston 4 is formed with a plurality of communicating through holes 44, the fluid pressure respectively inside and outside of conical head portion 41 can be balanced, so that the valve piston 4, when axially moving, has no resistance caused by the static pressure difference between the inside and outside of the cylindrical head portion 41, and so that the operation torque required for rotating the valve stem 8 can be reduced, and the vibration and noise caused by the pressure difference between the inside and outside of the cylindrical head portion 41 can be reduced. Besides, the disc springs 36 disposed on the push rod 3 are also helpful in inhibiting and diminishing the vibration and noise caused by the variation of fluid flow pressure.

As illustrated in FIGS. 5 and 7, the through bores 54 formed on the annular sleeve 5 can be simple elongate slots or V-shaped ports, so as to satisfy different operational flow characteristics as desired, such as for linear or proportional control. The through bores 54 are also helpful in effectively reducing the vibration and noise of the fluid flow.

As can be seen in FIGS. 5 and 6, since the cylinder 2 and the valve body 1 of the axial flow control valve are manufactured separately, the construction of the valve body 1 to be cast can be significantly simplified, to facilitate the manufacture and the reduction of cost for manufacture. Since the remaining parts, such as the cylinder 2, the push rod 3, the valve piston 4, the annular sleeve 5, and the positioning sleeve 6 can be sequently disposed into the valve body 1, the assembling and disassembling operations for manufacturing and repairing the valve are very convenient.

A conventional axial flow control valve essentially has beneficial characteristics of low-pressure drop, high fluid flow, steady fluid flow and low operational torque. The present invention improves conventional axial flow control valves by maintaining the inherent beneficial characteristics of conventional axial flow control valve, and improves the problems of unsuitable for use in a high-temperature condition and vibration noise, and further reduces the operational torque and vibration noise, and thus provides an improved axial flow control valve having the beneficial characteristics—low pressure drop, high fluid flow, reduced noise and vibration, suitable for use in high-temperature condition, less frictional resistance between the valve piston and the valve seat, minimized operational torque, simplified construction, and ease of manufacturing.

The above-described embodiment of the present invention is intended to illustrate only. Numerous alternative embodiments may be devised by persons skilled in the art without departing from the scope of the following claims.

What is claimed is:

1. An axial flow control valve, comprising:
a valve body having a longitudinal axis and being formed along a fluid flowing direction with an inlet flow passage, a valve chamber and an outlet flow passage, in which the valve body is formed with a through hole perpendicular to the longitudinal axis, corresponding to the valve chamber of the valve body;
a cylinder detachably disposed within the valve chamber, having a first end and a second end, in which the first end faces to the inlet flow passage and is formed as a conical diverter, and the second end formed with a central push rod hole and a cylindrical flange, a valve stem inserting hole formed on a lateral wall of the cylinder at a place corresponding to the through hole of the valve body;
a push rod having a first end and a second end, in which the first end is formed with a rack and slidably displaceable within the push rod hole of the cylinder, and the second end projecting out of the push rod hole;
a valve piston substantially in a cylindrical configuration, including a conical head portion and a cylindrical skirt portion, in which the head portion is formed with a central shaft hole to engage the second end of the push rod, so that the skirt portion of the valve piston is axially displaceable within the cylindrical flange of the cylinder, and an annular sealing edge formed at the intersection of the cylindrical head portion and the cylindrical skirt portion;
an annular sleeve substantially in a cylindrical configuration, interposed between the valve chamber and the outlet flow passage, and formed with a first end, a second end, and a cylindrical wall member formed between the first end and the second end, the wall member formed with a plurality of through bores, the first end adapted to engage the cylindrical flange of the second end of the cylinder, to allow the valve piston to slidably move between the first and the second ends of the annular sleeve;
a positioning sleeve substantially in a cylindrical configuration and having a first end and a second end, in which the first end compressively engages the second end of the annular sleeve and formed with a conical valve seat to sealingly engage the annular sealing edge of the valve piston;
a valve bonnet comprising a central valve stem tube formed therein with a central valve stem hole, the valve stem tube passing through the through hole of the valve body, extending to the valve chamber to engaging the valve stem inserting hole of the cylinder; and
a valve stem having a first end and a second end, in which the first end is formed with a gear and pivotally passing through the central valve stem hole of the valve bonnet and extending into the cylinder to drivingly engage the rack of the push rod.

2. The axial flow control valve of claim 1, wherein the through bores formed on the wall member of the annular sleeve are elongate slots or multi-pores construction, so as to form a multi-pores or V-shaped ports construction.

3. The axial flow control valve of claim 1, wherein the valve sleeve has an inner bottom formed with a circular recess for pivoting the valve stem.

4. The axial flow control valve of claim 1, wherein the valve piston engages the valve seat at an annular or truncated conical interface.

5. The axial flow control valve of claim 1, wherein the valve piston is made of ceramic material.

6. The axial flow control valve of claim 1, further comprising an O-ring made of resiliently metallic or ceramic material, is provided between the valve piston and the cylinder, or between the push rod and the cylindrical flange of the cylinder.

7. The axial flow control valve of claim 1, further comprising graphitic stuffing material interposing between the valve body and the valve bonnet, and between the valve bonnet and the cylinder, and between the cylinder and the valve body for sealing.

8. The axial flow control valve of claim 1, further comprising a resiliently biasing means interposed between the valve piston and the push rod for resiliently biasing the valve piston against the push rod.

9. The axial flow control valve of claim 8, wherein the resiliently biasing means is a plurality of disc springs co-axially arranged about the second end of the push rod.

10. The axial flow control valve of claim 6, wherein the resiliently metallic O-ring includes an annular ring made of metallic material and having an outer circumferential surface and an inner circumferential surface, in which the outer circumferential surface is formed with a radially extending opening and attached with heat-resistant graphitic material thereon, to receive and sealingly engage an annular sealing groove formed at the second end of the cylinder; the inner circumferential surface formed in a closed configuration, having a smooth sliding contact surface for resiliently sealing against the skirt portion of the valve piston, so that the valve piston is axially slidable relatively to the resiliently metallic O-ring.

11. The axial flow control valve of claim 10, wherein the resilient metallic O-ring is made of metallic material, having a V-shaped or trapezoidal transversely cross-section;

12. A sealing member for use in sealing between two relatively axially movable elements, comprising:
an annular ring made of metallic material and formed in a closed ring having an outer circumferential surface and an inner circumferential surface, in which the outer circumferential surface is formed with a radially opening, and the inner circumferential surface formed in a closed configuration, having a smooth sliding contact surface; and
a graphitic sealing layer adhered on the outer circumferential surface of the annular ring.

13. The sealing member for use in sealing between two relatively axially movable elements of claim 12, wherein the annular ring has a V-shaped transverse cross-section.
